(19) United States
(12) Patent Application Publication
(10) Pub. No.: US 2024/0142582 A1
(43) Pub. Date: May 2, 2024

(54) SCANNING APPARATUS CONTROLLING METHOD, ELECTRONIC DEVICE AND LIDAR

(71) Applicant: SUTENG INNOVATION TECHNOLOGY CO., LTD., Shenzhen (CN)

(72) Inventor: Rongtong MA, Shenzhen (CN)

(73) Assignee: SUTENG INNOVATION TECHNOLOGY CO., LTD., Shenzhen (CN)

(21) Appl. No.: 18/372,678

(22) Filed: Sep. 25, 2023

(30) Foreign Application Priority Data
Oct. 31, 2022 (CN) 202211343608.5

(51) Int. Cl. G01S 7/481

(52) U.S. Cl. CPC G01S 7/4817

(57) ABSTRACT

This application is applicable to the technical field of LiDAR, and provides a scanning apparatus controlling method, an electronic device and a LiDAR. The scanning apparatus controlling method includes: obtaining first movement information of a first scanning apparatus at a current moment, where the first movement information includes any one or more of a position, an angular velocity and angular acceleration; predicting a position of a second scanning apparatus at a next moment based on the first movement information and a relative positional relationship between the first scanning apparatus and the second scanning apparatus; and controlling rotation of the second scanning apparatus based on the position of the second scanning apparatus at the next moment so that the second scanning apparatus can be rotated along with an actual position of the first scanning apparatus, thereby improving repeatability of scanning tracks formed by laser beams.

### CROSS-REFERENCE TO RELATED APPLICATION

The present application claims the benefit of priority to Chinese Patent Application No. 202211343608.5, filed on Oct. 31, 2022, which is hereby incorporated by references in its entirety.

### TECHNICAL FIELD

This application relates to the technical field of LiDAR (Light Detection and Ranging), and in particular, relates to a scanning apparatus controlling method, an electronic device and a LiDAR.

### TECHNICAL BACKGROUND

In some cases, when a LiDAR system includes multiple scanning apparatuses, a movement track of each scanning apparatus is usually planned separately. After a LiDAR is mounted on an equipment such as a car and a robot, during an operation of the equipment, the equipment may bump. As a result, the LiDAR is dislocated under interference of an external force. Due to inertia, a position or an angular velocity of the scanning apparatus may change. When there are multiple scanning apparatuses, positions or angular velocities of the scanning apparatuses may change to different extents, and as a result, a scanning track of a laser beam seriously deforms, and repeatability of scanning tracks becomes poor, thereby affecting detection performance of the LiDAR.

### SUMMARY

In view of this, embodiments of this application provide a scanning apparatus controlling method, an electronic device and a LiDAR, to resolve the problem of poor repeatability of scanning tracks formed by laser beams in existing scanning apparatus controlling methods.

A first aspect of the embodiments of this application provides a scanning apparatus controlling method, applied to a LiDAR, where the LiDAR includes a laser emission apparatus and at least two scanning apparatuses, and a laser beam emitted by the laser emission apparatus is reflected by the at least two scanning apparatuses and then is directed to a detection region, where the method includes:

obtaining first movement information of a first scanning apparatus at a current moment, where the first movement information includes any one or more of a position, an angular velocity and angular acceleration, and the first scanning apparatus is one of the at least two scanning apparatuses;

predicting a position of a second scanning apparatus at a next moment based on the first movement information and a relative positional relationship between the first scanning apparatus and the second scanning apparatus, where the second scanning apparatus is one of the at least two scanning apparatuses; and

controlling rotation of the second scanning apparatus based on the position of the second scanning apparatus at the next moment.

In an embodiment, the first movement information includes the position, the angular velocity and the angular acceleration, and predicting the position of the second scanning apparatus at the next moment based on the first movement information and the relative positional relationship between the first scanning apparatus and the second scanning apparatus includes:

determining a theoretic position, a theoretic angular velocity and theoretic angular acceleration of the second scanning apparatus at the current moment based on the first movement information and the relative positional relationship between the first scanning apparatus and the second scanning apparatus; and

determining the position of the second scanning apparatus at the next moment based on the theoretic position, the theoretic angular velocity and the theoretic angular acceleration of the second scanning apparatus at the current moment, and a movement model of the second scanning apparatus.

In an embodiment, the first movement information includes the position, the angular velocity and the angular acceleration, and predicting the position of the second scanning apparatus at the next moment based on the first movement information and the relative positional relationship between the first scanning apparatus and the second scanning apparatus further includes:

determining a position of the first scanning apparatus at the next moment based on the first movement information and a movement model of the first scanning apparatus; and

determining the position of the second scanning apparatus at the next moment based on the position of the first scanning apparatus at the next moment and the relative positional relationship between the first scanning apparatus and the second scanning apparatus.

In an embodiment, after determining the position of the first scanning apparatus at the next moment, the method further includes:

adjusting an angular velocity and/or angular acceleration of the first scanning apparatus based on the position of the first scanning apparatus at the next moment and a movement track of the first scanning apparatus that is planned in advance.

In an embodiment, before obtaining the first movement information of the first scanning apparatus at the current moment, the method further includes: obtaining moments of inertia of the at least two scanning apparatuses; and if a difference between the moments of inertia of the at least two scanning apparatuses is greater than a preset difference, using a scanning apparatus with the largest moment of inertia as the first scanning apparatus.

In an embodiment, after obtaining the moments of inertia of the at least two scanning apparatuses, the method further includes: if the difference between the moments of inertia of the at least two scanning apparatuses is less than or equal to the preset difference, using a scanning apparatus with the highest velocity as the first scanning apparatus.

In an embodiment, the first scanning apparatus is a rotating mirror, the second scanning apparatus is a galvanometer, and the laser beam emitted by the laser emission apparatus is reflected by the galvanometer and directed to the rotating mirror, and is further reflected by the rotating mirror and directed to the detection region.

In an embodiment, the method further includes: based on the first movement information, determining a first duration during which the first scanning apparatus rotates by a preset angular interval, and using the first duration as an emission time interval between emissions of two adjacent laser beams.

In an embodiment, the method further includes: determining a first moment when the first scanning apparatus rotates to a preset first position, and a second moment when the first scanning apparatus rotates to a preset second position; and controlling the laser emission apparatus to start emitting a laser beam at the first moment and stop emitting the laser beam at the second moment.

In an embodiment, the first moment is a rising edge moment of a narrow pulse of a time synchronization signal, and before determining the first moment when the first scanning apparatus rotates to a preset first position, the method further includes:

adjusting the angular velocity of the first scanning apparatus, so that the first scanning apparatus rotates to the first position at the first moment.

A second aspect of the embodiments of this application provides a scanning apparatus controlling apparatus, applied to a LiDAR, where the LiDAR includes a laser emission apparatus and at least two scanning apparatuses, and a laser beam emitted by the laser emission apparatus is reflected by the at least two scanning apparatuses and then is directed to a detection region, where the apparatus includes:

an obtaining module, configured to obtain first movement information of a first scanning apparatus at a current moment, where the first movement information includes any one or more of a position, an angular velocity and angular acceleration, and the first scanning apparatus is one of the at least two scanning apparatuses;

a predicting module, configured to predict a position of a second scanning apparatus at a next moment based on the first movement information and a relative positional relationship between the first scanning apparatus and the second scanning apparatus, where the second scanning apparatus is one of the at least two scanning apparatuses; and

a controlling module, configured to control rotation of the second scanning apparatus based on the position of the second scanning apparatus at the next moment.

In an embodiment, the first movement information includes the position, the angular velocity and the angular acceleration, and the predicting module is specifically configured to: determine a theoretic position, a theoretic angular velocity and theoretic angular acceleration of the second scanning apparatus at the current moment based on the first movement information and the relative positional relationship between the first scanning apparatus and the second scanning apparatus; and determine the position of the second scanning apparatus at the next moment based on the theoretic position, the theoretic angular velocity and the theoretic angular acceleration of the second scanning apparatus at the current moment, and a movement model of the second scanning apparatus.

In an embodiment, the first movement information includes the position, the angular velocity and the angular acceleration, and the predicting module is specifically configured to:

determine a position of the first scanning apparatus at the next moment based on the first movement information and a movement model of the first scanning apparatus; and

determine the position of the second scanning apparatus at the next moment based on the position of the first scanning apparatus at the next moment and the relative positional relationship between the first scanning apparatus and the second scanning apparatus.

In an embodiment, the controlling module is further configured to: adjust an angular velocity and/or angular acceleration of the first scanning apparatus based on the position of the first scanning apparatus at the next moment and a movement track of the first scanning apparatus that is planned in advance.

In an embodiment, the obtaining module is further configured to: obtain moments of inertia of the at least two scanning apparatuses; and if a difference between the moments of inertia of the at least two scanning apparatuses is greater than a preset difference, use a scanning apparatus with the largest moment of inertia as the first scanning apparatus.

In an embodiment, the obtaining module is further configured to: if the difference between the moments of inertia of the at least two scanning apparatuses is less than or equal to the preset difference, use a scanning apparatus with the highest velocity as the first scanning apparatus.

In an embodiment, the first scanning apparatus is a rotating minor, the second scanning apparatus is a galvanometer, and the laser beam emitted by the laser emission apparatus is reflected by the galvanometer and directed to the rotating minor, and is further reflected by the rotating minor and directed to the detection region.

In an embodiment, the controlling module is further configured to: based on the first movement information, determine a first duration during which the first scanning apparatus rotates by a preset angular interval, and use the first duration as an emission time interval between emissions of two adjacent laser beams.

In an embodiment, the controlling module is further configured to: determine a first moment when the first scanning apparatus rotates to a preset first position, and a second moment when the first scanning apparatus rotates to a preset second position; and control the laser emission apparatus to start emitting a laser beam at the first moment and stop emitting the laser beam at the second moment.

In an embodiment, the first moment is a rising edge moment of a narrow pulse of a time synchronization signal, and the controlling module is further configured to:

adjust the angular velocity of the first scanning apparatus, so that the first scanning apparatus rotates to the first position at the first moment.

A third aspect of the embodiments of this application provides an electronic device, including a memory, a processor, and a computer program stored in the memory and capable of running on the processor, where when the processor executes the computer program, the scanning apparatus controlling method in the first aspect is implemented.

A fourth aspect of the embodiments of this application provides a computer-readable storage medium, where the computer-readable storage medium stores a computer program, and when the computer program is executed by a processor, the scanning apparatus controlling method in the first aspect is implemented.

A fifth aspect of the embodiments of this application provides a computer program product, where when the computer program product runs on an electronic device, the electronic device performs the scanning apparatus controlling method in any embodiment of the first aspect.

A sixth aspect of the embodiments of this application provides a LiDAR, including a laser emission apparatus, a first scanning apparatus, a second scanning apparatus, and the electronic device in the foregoing third aspect.

Compared with the related arts, the embodiments of this application have the following beneficial effects: the position of the second scanning apparatus at the next moment is predicted with reference to the relative positional relationship between the first scanning apparatus and the second scanning apparatus and with reference to any one or more of the position, the angular velocity and the angular acceleration of the first scanning apparatus that are obtained at the current moment. The rotation of the second scanning apparatus is further controlled based on the position of the second scanning apparatus at the next moment. Therefore, the second scanning apparatus can be rotated along with the first scanning apparatus to implement synchronization between the first scanning apparatus and the second scanning apparatus. A change in a rotation velocity of the first scanning apparatus under the interference of the external force is compensated for, so that an error between relative positions and relative positions that are actually set regarding the first scanning apparatus and the second scanning apparatus is reduced, thereby improving the repeatability of the scanning tracks formed by the laser beams and further improving the detection performance of the LiDAR.

### BRIEF DESCRIPTION OF DRAWINGS

In order to describe technical solutions in embodiments of this application more clearly, the following briefly describes drawings required for description of the embodiments.

FIG. 1 is a schematic diagram of a LiDAR according to an embodiment of this application;

FIG. 2 is a schematic diagram of a scanning field of view formed by a laser beam according to an embodiment of this application;

FIG. 3 is a schematic flowchart of implementation of a scanning apparatus controlling method according to an embodiment of this application; and

FIG. 4 is a schematic structural diagram of an electronic device according to an embodiment of this application.

### DETAILED DESCRIPTION

For the purpose of illustration rather than limitation, the following describes details such as a system structure and technology, to facilitate a thorough understanding of the embodiments of this application. In other cases, detailed descriptions of well-known systems, apparatuses, circuits, and methods are omitted, to prevent unnecessary details from causing distraction from the description of this application.

It should be understood that when used in this specification and appended claims, a term “include” indicates existence of a described feature, integrity, a step, an operation, an element and/or a component, but does not exclude existence or addition of one or more other features, integrity, steps, operations, elements, components and/or a collection thereof.

In addition, in the description of the present application, the terms such as “first” and “second” are merely intended for a purpose of description, and shall not be understood as an indication or implication of relative importance.

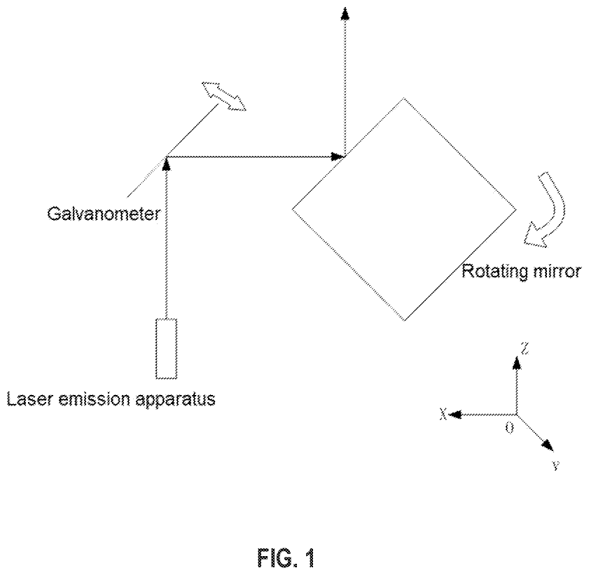

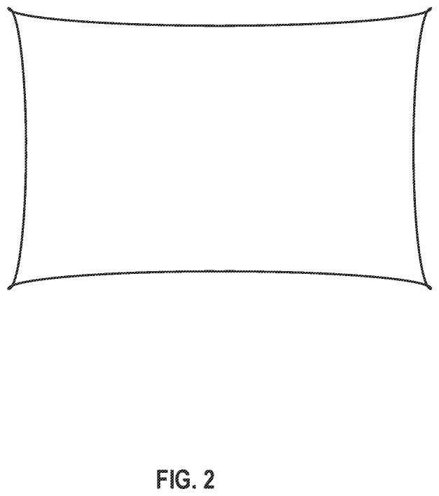

As shown in FIG. 1, in a LiDAR, a laser beam emitted by the laser emission apparatus is directed to a galvanometer, is reflected by the galvanometer and then directed to a rotating mirror, and is reflected by the rotating mirror and then directed to a detection region. When positions of the galvanometer and the rotating mirror change, a position of a light spot formed by the laser beam in the detection region also changes. For example, rotation of the galvanometer causes a change in the position of the light spot in a vertical direction, and rotation of the rotating mirror causes a change in the position of the light spot in a horizontal direction. By setting movement tracks of the galvanometer and the rotating mirror, while the laser emission apparatus continuously emits laser beams, the galvanometer and the rotating mirror respectively move based on set movement tracks, so that multiple scanning tracks can be formed in the detection region. By setting the relative positions of the galvanometer and the rotating minor, the scanning tracks formed by the laser beams are respectively along the horizontal direction and the vertical direction during rotation of the galvanometer and the rotating mirror, so that the scanning tracks can form the scanning field of view shown in FIG. 2.

In an example, the movement track of the galvanometer and the movement track of the rotating mirror are generally planned separately. Under interference of an external force, the galvanometer and the rotating minor may deviate from an actual movement track, and as a result, the position of the galvanometer cannot correspond to that of the rotating mirror, and the position of the light spot formed by the laser beam is inconsistent with the set position, thereby causing poor repeatability of the scanning tracks formed by the laser beams.

Therefore, this application provides a scanning apparatus controlling method. First movement information of a first scanning apparatus at a current moment is obtained, where the first movement information includes any one or more of a position, an angular velocity and angular acceleration; a position of a second scanning apparatus at the next moment is predicted based on the first movement information and relative position of the first scanning apparatus and the second scanning apparatus; and rotation of the second scanning apparatus is controlled based on the position of the second scanning apparatus at a next moment. In this way, a movement of the second scanning apparatus can be controlled based on the position of the first scanning apparatus, so that the position of the first scanning apparatus corresponds to that of the second scanning apparatus, to implement synchronous movement of the position of the first scanning apparatus and the second scanning apparatus, thereby improving a LiDAR's capability of resisting interference of an external force. When the laser beam emitted by the laser emission apparatus is reflected by the first scanning apparatus and the second scanning apparatus and then is directed to the detection region, the change in the scanning track formed in the detection region can be small each time, and the repeatability of the scanning tracks is improved, thereby improving the detection performance of the LiDAR.

The scanning apparatus controlling method provided in this application is exemplarily described below.

The scanning apparatus controlling method provided in the embodiments of this application is applied to the LiDAR, where the LiDAR includes a laser emission apparatus and at least two scanning apparatuses, and a laser beam emitted by the laser emission apparatus is reflected by the at least two scanning apparatuses and then is directed to a detection region. The scanning apparatus controlling method provided in the embodiments of this application is executed by an electronic device to control rotation of the at least two scanning apparatuses.

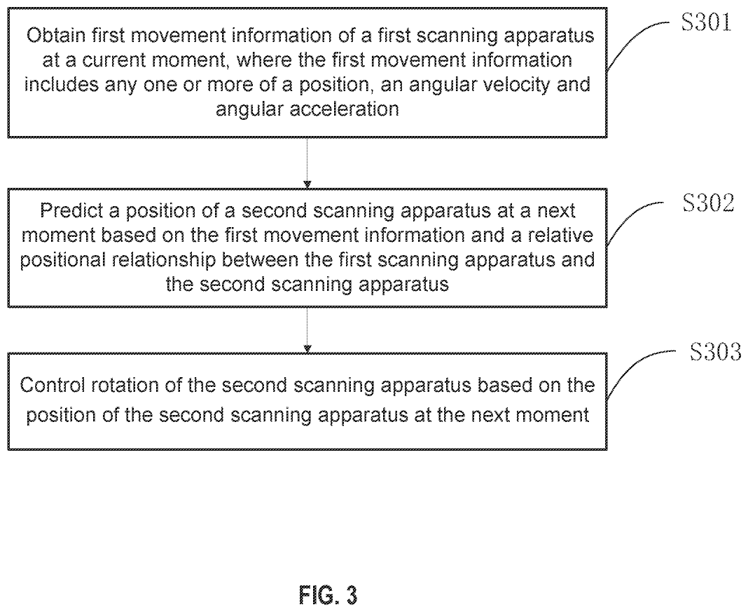

Referring to FIG. 3, the scanning apparatus controlling method provided in this embodiment of this application includes the following steps:

S301. Obtain first movement information of a first scanning apparatus at a current moment, where the first movement information includes any one or more of a position, an angular velocity and angular acceleration, and the first scanning apparatus is one of the at least two scanning apparatuses.

In an embodiment, the first scanning apparatus may be a galvanometer, or may be a rotating mirror or a rotating platform. The rotating mirror may be a rotating polygonal mirror, and this application imposes no limitation on the number of reflecting surfaces of the rotating mirror. The position of the first scanning apparatus, that is, the angle of the first scanning apparatus, can be collected by a position feedback sensor mounted on a motor of the first scanning apparatus. After obtaining the position of the first scanning apparatus from the position feedback sensor, an electronic device performs a derivation operation on the position and performs filtering processing to obtain a current angular velocity of the first scanning apparatus. Then the electronic device performs a derivation operation on the angular velocity, and then performs filtering processing to obtain angular acceleration.

The electronic device may also receive angular acceleration collected by an acceleration sensor mounted on the first scanning apparatus, and performs an integration operation on the angular acceleration to obtain the angular velocity and the position.

S302. Predict a position of a second scanning apparatus at a next moment based on the first movement information and a relative positional relationship between the first scanning apparatus and the second scanning apparatus, where the second scanning apparatus is one of the at least two scanning apparatuses.

The second scanning apparatus may be the same as or different from the first scanning apparatus, and the second scanning apparatus may also be a galvanometer, a rotating mirror or a rotating platform.

In an embodiment, the first movement information includes the position, the angular velocity and the angular acceleration. The electronic device determines a position of the first scanning apparatus at the next moment based on the first movement information and a movement model of the first scanning apparatus, and determines the position of the second scanning apparatus at the next moment based on the position of the first scanning apparatus at the next moment and the relative position of the first scanning apparatus and the second scanning apparatus. The position of the second scanning apparatus at the next moment is a predicted position of the second scanning apparatus.

In an embodiment, the electronic device inputs the position, the angular velocity and the angular acceleration into the movement model of the first scanning apparatus, to obtain the position of the first scanning apparatus at the next moment that is output via the movement model of the first scanning apparatus. The movement model of the first scanning apparatus may be a preset movement equation for characterizing a correspondence between a motor parameter, the position, the angular velocity and the angular acceleration of the first scanning apparatus.

After the position of the first scanning apparatus at the next moment is obtained, based on the relative position of the first scanning apparatus and the second scanning apparatus, the position of the second scanning apparatus at the next moment is determined, so that the position of the second scanning apparatus at the next moment can correspond to the position of the first scanning apparatus at the next moment, thereby compensating for a change in the position or the angular velocity of the first scanning apparatus that is caused by the interference of the external force. The relative positional relationship between the first scanning apparatus and the second scanning apparatus refers to a relative positional relationship between the first scanning apparatus and the second scanning apparatus at the next moment, which can be determined based on a preset relative positional relationship between the first scanning apparatus and the second scanning apparatus at each moment.

Exemplarily, if the first scanning apparatus and the second scanning apparatus are the galvanometer and the rotating mirror respectively, a position of a light spot at each moment can be determined based on a scanning track of the laser beam that is planned in advance, and based on the position of the light spot at each moment and a distance between the galvanometer and the rotating mirror, positions of the galvanometer and the rotating mirror at each moment can be obtained. After the position of the rotating mirror at the next moment is determined, the position of the galvanometer at the next moment can be determined by searching for the positions of the galvanometer and the rotating mirror at each moment.

For example, when an angle θ of the rotating mirror is 15° and an angle φ of the galvanometer is 10°, the light spot formed by the laser beam is located at an upper right corner of a rectangular field of view; when the angle θ of the rotating mirror is 75° and the angle φ of the galvanometer is 10°, the light spot formed by the laser beam is located at an upper left corner of the rectangular field of view; when the angle θ of the rotating mirror is 15° and the angle φ of the galvanometer is −10°, the light spot formed by the laser beam is located at a lower right corner of the rectangular field of view; or when the angle θ of the rotating mirror is 75° and the angle φ of the galvanometer is −10°, the light spot formed by the laser beam is located at a lower left corner of the rectangular field of view. At any moment, based on the foregoing correspondence and a position of one scanning apparatus, a position of the other scanning apparatus can be determined.

In another embodiment, the first movement information includes the angular velocity and the position. The electronic device can calculate a position at the next moment during uniform motion based on the position and the angular velocity of the first scanning apparatus at the current moment, and can use the calculated position as a position of the first scanning apparatus at the next moment. Then the electronic device further determines the position of the second scanning apparatus at the next moment based on the position of the first scanning apparatus at the next moment and the relative position of the first scanning apparatus and the second scanning apparatus.

In another embodiment, the first movement information includes the position, the angular velocity and the angular acceleration, the electronic device determines a theoretic position, a theoretic angular velocity and theoretic angular acceleration of the second scanning apparatus at the current moment based on the first movement information and the relative positional relationship between the first scanning apparatus and the second scanning apparatus. That is, when the first scanning apparatus rotates rapidly, the second scanning apparatus also rotates rapidly, and when the position of the first scanning apparatus changes greatly, the second scanning apparatus also moves greatly synchronously, to implement synchronization of the first scanning apparatus and the second scanning apparatus, thereby compensating for a change in the position or the angular velocity of the first scanning apparatus under the interference of an external force. Then the electronic device determines a position of the second scanning apparatus at the next moment based on the theoretic position, the theoretic angular velocity and the theoretic angular acceleration of the second scanning apparatus at the current moment, and a movement model of the second scanning apparatus, so that the position of the second scanning apparatus at the next moment corresponds to the position of the first scanning apparatus at the next moment.

In an embodiment, the relative positional relationship between the first scanning apparatus and the second scanning apparatus refers to a relative positional relationship between the first scanning apparatus and the second scanning apparatus at the current moment, which can be determined based on a preset relative positional relationship between the first scanning apparatus and the second scanning apparatus at each moment.

The electronic device can find a theoretic position of the second scanning apparatus at the current moment based on the relative positional relationship between the first scanning apparatus and the second scanning apparatus at the current moment. Then the electronic device can determine a theoretical angular velocity of the second scanning apparatus at the current moment based on the angular velocity of the first scanning apparatus at the current moment and a correspondence between angular velocities of the first scanning apparatus and the second scanning apparatus, and further determine theoretical angular acceleration of the second scanning apparatus at the current moment based on the angular acceleration of the first scanning apparatus at the current moment and a correspondence between angular acceleration of the first scanning apparatus and the second scanning apparatus. Both the correspondence between the angular velocities of the first scanning apparatus and the second scanning apparatus and the correspondence between the angular acceleration of the first scanning apparatus and the second scanning apparatus can be preset proportional coefficients. The electronic device can also determine the theoretical angular velocity and the theoretical angular acceleration of the second scanning apparatus at the current moment based on the theoretical position at the current moment and the preset correspondence between the position, the angular velocity and the angular acceleration of the second scanning apparatus.

After determining the theoretical position, the theoretical angular velocity and the theoretical angular acceleration of the second scanning apparatus at the current moment, the electronic device inputs the theoretical position, the theoretical angular velocity and the theoretical angular acceleration into the movement model of the second scanning apparatus so that the position of the second scanning apparatus at the next moment can be obtained. The movement model of the second scanning apparatus may be a preset movement equation for characterizing a correspondence between a motor parameter, the position, the angular velocity and the angular acceleration of the second scanning apparatus.

In another embodiment, the first movement information can also include only the position, and the electronic device can find a theoretic position of the second scanning apparatus at the current moment based on the position of the first scanning apparatus at the current moment and the relative positional relationship between the first scanning apparatus and the second scanning apparatus. Then the electronic device can determine a theoretical angular velocity of the second scanning apparatus at the current moment based on the angular velocity of the first scanning apparatus at the current moment and a correspondence between angular velocities of the first scanning apparatus and the second scanning apparatus. Then the electronic device can calculate a position at the next moment during uniform motion based on the theoretical position and the theoretical angular velocity of the second scanning apparatus and then use the calculated position as a position of the second scanning apparatus at the next moment.

S303. Control rotation of the second scanning apparatus based on the position of the second scanning apparatus at the next moment.

In an embodiment, the position of the second scanning apparatus at the current moment collected by the position feedback sensor on the motor of the second scanning apparatus is obtained, and the angular velocity of the second scanning apparatus is adjusted based on the position of the second scanning apparatus at the current moment and the position at the next moment, so that the second scanning apparatus rotates to the position at the next moment.

The movement track (that is, positions at each moment) of the first scanning apparatus can be planned in advance, so that the first scanning apparatus moves along the planned movement track. Because the first scanning apparatus easily deviates from the preset movement track under the impact of the external force, it is necessary to update the first movement information of the first scanning apparatus at the current moment in real time, and then the foregoing steps are performed to predict the position of the second scanning apparatus at the next moment based on the first movement information, so that the position of the first scanning apparatus corresponds to the position of the second scanning apparatus, thereby improving the repeatability of the formed scanning tracks.

In an embodiment, after the position of the first scanning apparatus at the next moment is determined based on the first movement information of the first scanning apparatus at the current moment and the movement model of the first scanning apparatus, a difference between the position of the first scanning apparatus at the next moment and the position at the next moment in the movement track of the first scanning apparatus that is planned in advance is determined, and the angular velocity and/or the angular acceleration of the first scanning apparatus is adjusted based on the difference, so that the first scanning apparatus can better rotate along the planned movement track, thereby improving the repeatability of the scanning tracks formed by the laser beams.

In another embodiment, the difference between the position at the current moment in the movement track of the first scanning apparatus that is planned in advance and the position of the first scanning apparatus at the current moment that is detected by the position feedback sensor can also be used as feedback, and based on the feedback, a control parameter of the motor of the first scanning apparatus is adjusted, so that the position of the first scanning apparatus at the next moment is closer to a corresponding position in the planned movement track, and the first scanning apparatus can better rotate along the planned movement track.

In an embodiment, before obtaining the first movement information of the first scanning apparatus at the current moment, the electronic device first determines the first scanning apparatus and the second scanning apparatus of the at least two scanning apparatuses.

In an embodiment, the electronic device obtains moments of inertia of the at least two scanning apparatuses and uses a scanning apparatus with the largest moment of inertia as the first scanning apparatus if a difference between the moments of inertia of the at least two scanning apparatuses is greater than a preset difference. For example, if the number of scanning apparatuses is two and a difference between the moments of inertia of the two scanning apparatuses is greater than a preset difference, a scanning apparatus with the larger moment of inertia is used as the first scanning apparatus, and a scanning apparatus with the smaller moment of inertia is used as the second scanning apparatus. If the number of scanning apparatuses is three and a difference between moments of inertia of two scanning apparatuses of the three scanning apparatuses is greater than a preset difference, a scanning apparatus with the largest moment of inertia is used as the first scanning apparatus, and the other two scanning apparatuses are used as the second scanning apparatus and the third scanning apparatus. Movement tracks of the second scanning apparatus and the third scanning apparatus are respectively synchronized with the movement of the first scanning apparatus.

That is, the electronic device first obtains movement information at the current moment of a scanning apparatus with a larger moment of inertia, and then controls a scanning apparatus with a smaller moment of inertia to move along with the scanning apparatus with the larger moment of inertia. Because the scanning apparatus with the larger moment of inertia changes greatly in the velocity under impact of an external force, it is easier to control a velocity of the scanning apparatus with the smaller moment of inertia by controlling the scanning apparatus with the smaller moment of inertia to move along with the scanning apparatus with the larger moment of inertia, which can better implement synchronization between the first scanning apparatus and the second scanning apparatus.

In an embodiment, after the electronic device obtains moments of inertia of the at least two scanning apparatuses, if the difference between the moments of inertia of the at least two scanning apparatuses is less than or equal to a preset value (that is, the at least two scanning apparatuses have similar moments of inertia), the electronic device obtains velocities of the at least two scanning apparatuses and uses a scanning apparatus with the highest velocity as the first scanning apparatus. For example, if the number of scanning apparatuses is two, a scanning apparatus with a higher velocity is used as the first scanning apparatus, and a scanning apparatus with a lower velocity is used as the second scanning apparatus. If the number of scanning apparatuses is three, a scanning apparatus with the highest velocity is used as the first scanning apparatus, and the other two scanning apparatuses are used as the second scanning apparatus and the third scanning apparatus. Movement tracks of the second scanning apparatus and the third scanning apparatus are respectively synchronized with the movement of the first scanning apparatus.

That is, if the at least two scanning apparatuses have similar moments of inertia, the velocities of the at least two scanning apparatuses are compared, and the electronic device obtains the movement information of the scanning apparatus with a higher velocity at the current moment, to further control the scanning apparatus with a lower velocity to move along with the scanning apparatus with a higher velocity, thereby better implementing synchronization between the first scanning apparatus and the second scanning apparatus.

If the LiDAR includes one first scanning apparatus and multiple second scanning apparatuses, each second scanning apparatus moves along with the first scanning apparatus, to implement synchronization between the multiple second scanning apparatuses and the first scanning apparatus.

In an embodiment, the first scanning apparatus is a rotating mirror, the second scanning apparatus is a galvanometer, and the laser beam emitted by the laser emission apparatus is reflected by the galvanometer and directed to the rotating mirror, and further reflected by the rotating mirror and directed to the detection region. The electronic device predicts the position of the galvanometer at the next moment according to the position, the angular velocity and the angular acceleration of the rotating mirror at each moment, and controls rotation of the galvanometer according to the position of the galvanometer at the next moment, to implement synchronous movement of the galvanometer and the rotating mirror, thereby reducing the impact of the rotation of the galvanometer and the rotating mirror that is caused by an external force on the scanning track and improving an anti-interference capability of the LiDAR. As a moment of inertia of the rotating mirror is larger than that of the galvanometer, a change in the velocity of the rotating mirror is greater under the impact of the external force. Therefore, controlling the rotation of the galvanometer according to the movement of the rotating mirror can better implement synchronization between the galvanometer and the rotating mirror.

In an embodiment, the electronic device determines a first moment when the first scanning apparatus rotates to a preset first position (for example, 0° or 15°), and a second moment when the first scanning apparatus rotates to a preset second position (for example, 75° or 90°), and controls the laser emission apparatus to start emitting the laser beam at the first moment and stop emitting the laser beam at the second moment, so that the laser beam can be emitted at an appropriate time according to the scanning field of view of the LiDAR, thereby implementing synchronization between the emission time of the laser beam and the rotation angle of the first scanning apparatus. Because the second scanning apparatus is synchronized with the first scanning apparatus, synchronization between the emission time of the laser beam, the rotation angle of the first scanning apparatus, and the rotation angle of the second scanning apparatus can be implemented in the foregoing method. When the velocity of the first scanning apparatus changes due to the interference of the external force, emission time of the laser beam by the LiDAR and the movement velocity of the second scanning apparatus can be adjusted synchronously to realize synchronization therebetween, which can reduce the impact of the interference of the external force on the LiDAR, thereby improving the repeatability of the scanning tracks formed by the laser beams.

The electronic device can set synchronization time of the first scanning apparatus, the second scanning apparatus and the laser emission apparatus by emitting, for example, a narrow pulse of a time synchronization signal, using a rising edge moment of the narrow pulse of the time synchronization signal as synchronization time of the first scanning apparatus, the second scanning apparatus and the laser emission apparatus, fix the first scanning apparatus at the first position at the rising edge moment of the narrow pulse of the time synchronization signal, and then adjust the position of the second scanning apparatus and the emission time of the laser beam according to the first position.

In an embodiment, the rotation of the first scanning apparatus can be controlled, and the angular velocity of the first scanning apparatus can be adjusted according to the difference between the current position of the first scanning apparatus and the first position, so that the first scanning apparatus can rotate to the first position at the first moment and the first scanning apparatus can be closer to the first position.

In an embodiment, the number of light spots in the scanning track is planned in advance, and the number of light spots is the number of emissions of the laser beams required to form the scanning track. According to the scanning field of view of the LiDAR, the angle rotated by the first scanning apparatus in an emission time interval between emissions of two adjacent laser beams can be determined. For example, a rotation angle range of the first scanning apparatus is 15° to 75°, and during the rotation process, the laser beams are emitted 1200 times, and the first scanning apparatus rotates by 0.05° during the emission time interval between the emissions of two adjacent laser beams. The electronic device can determine a first duration for the first scanning apparatus to rotate by the preset angle according to the first movement information of the first scanning apparatus at the current moment, and use the first duration as the emission time interval between emissions of the two adjacent laser beams, so that the emission intervals of the laser beams synchronize with the rotation angle of the first scanning apparatus to realize synchronization between the first scanning apparatus and the laser emission apparatus.

In the foregoing embodiments, any one or more of the position, the angular velocity and the angular acceleration of the first scanning apparatus at the current moment are obtained; the position of the second scanning apparatus at the next moment is predicted with reference to the relative position of the first scanning apparatus and the second scanning apparatus; and the rotation of the second scanning apparatus is controlled based on the position of the second scanning apparatus at the next moment. Therefore, the position of the second scanning apparatus can be planned in real time according to the position of the first scanning apparatus, and the movement of the second scanning apparatus can be controlled according to the position planned in real time, so that the position of the first scanning apparatus can correspond to the position of the second scanning apparatus, to implement movement synchronization between the positions of the first scanning apparatus and the second scanning apparatus, thereby reducing impact of external interference on the scanning track formed by the laser beams. When the laser beam emitted by the laser emission apparatus is reflected by the first scanning apparatus and the second scanning apparatus and then directed to the detection region, the change in scanning track formed in the detection region can be small each time, and the repeatability of the scanning tracks is improved, thereby improving the detection performance of the LiDAR.

A sequence number of each step in the foregoing embodiments does not mean an execution sequence. An execution sequence of each process should be determined based on a function and internal logic of each process, and should not constitute any limitation to an implementation process of the embodiments of this application.

An embodiment of this application further provides a LiDAR, where the LiDAR includes a laser emission apparatus, a first scanning apparatus, a second scanning apparatus, and an electronic device. The electronic device is communicatively connected to the laser emission apparatus, the first scanning apparatus and the second scanning apparatus, and the electronic device can control emission time of a laser beam by the laser emission apparatus, and can also control positions, angular velocities and angular acceleration of the first scanning apparatus and the second scanning apparatus.

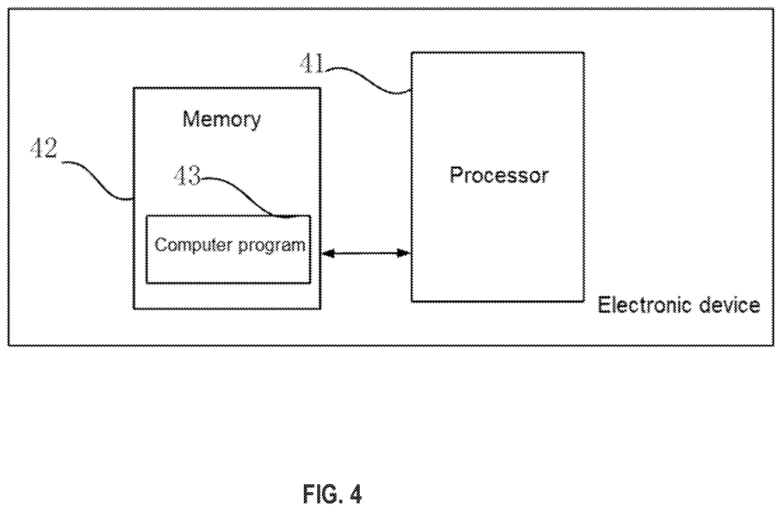

FIG. 4 is a schematic structural diagram of an electronic device according to an embodiment of this application. The electronic device can be mounted inside the LiDAR or can be independent of the LiDAR. If the electronic device is independent from the LiDAR, the electronic device can be a device such as a computer or a vehicle-mounted terminal.

As shown in FIG. 4, the electronic device in this embodiment includes: a processor 41, a memory 42, and a computer program 43 stored in the memory 42 and capable of running on the processor 41, where when the processor 41 executes the computer program 43, steps in the embodiments of the scanning apparatus controlling method are implemented, for example, steps S301 to S303 shown in FIG. 1. Alternatively, when the processor 41 executes the computer program 43, the functions of the modules/units in the foregoing apparatus embodiments are implemented.

For example, the computer program 43 may be divided into one or more modules or units, and the one or more modules or units are stored in the memory 42 and are performed by the processor 41 to implement this application. The one or more modules or units may be a series of computer program instruction fields capable of completing specific functions, and the instruction fields are used to describe an execution process of the computer program 43 in the electronic device.

The LiDAR may include more or fewer components than those shown in the figure, or a combination of some components, or different components. For example, the electronic device may also include input and output devices, a network access device, a bus, and the like.

The processor 41 may be a central processing unit (CPU), or may be another general-purpose processor, a digital signal processor (DSP), an application specific integrated circuit (ASIC), a field-programmable gate array (FPGA) or another programmable logic device, a discrete gate or transistor logic device, a discrete hardware component, or the like. The general-purpose processor can be a microprocessor, or the processor can be any conventional processor or the like.

The memory 42 may be an internal storage unit of the electronic device, for example, a hard disk or a memory of the electronic device. The memory 42 may alternatively be an external storage device of the electronic device, for example, a plug-connected hard disk, a smart media card (SMC), a secure digital (SD) card, or a flash card equipped on the electronic device. Further, the memory 42 may alternatively include both the internal storage unit and the external storage device of the electronic device. The memory 42 is configured to store the computer program and other programs and data required by the electronic device. The memory 42 can also be configured to temporarily store data that have been output or data to be output.

For the purpose of convenient and brief description, division of the foregoing functional units and modules is taken as an example for illustration. In actual application, the foregoing functions can be allocated to different units and modules and implemented according to a requirement, that is, an inner structure of an apparatus is divided into different functional units and modules to implement all or part of the functions described above. The functional units and modules in the embodiments may be integrated into one processing unit, or each unit may exist alone physically, or two or more units may be integrated into one unit. The integrated unit may be implemented in a form of hardware, or may be implemented in a form of a software functional unit. In addition, specific names of the functional units and modules are only for the convenience of distinguishing one another, and are not intended to limit the protection scope of this application. For a detailed working process of units and modules in the foregoing system, reference may be made to a corresponding process in the foregoing method embodiments. Details are not described again herein.

The units described as separate parts may or may not be physically separated, and parts displayed as units may or may not be physical units, may be located in one position, or may be distributed on a plurality of network elements. Some or all of the units may be selected based on actual requirements to achieve the objectives of the solutions of the embodiments.

When the integrated module or unit is implemented in the form of a software functional unit and sold or used as an independent product, the integrated module or unit may be stored in a computer-readable storage medium. Based on such understanding, some or all of the processes for implementing the methods in the embodiments of this application may be completed by related hardware instructed by a computer program. The computer program may be stored in a computer-readable storage medium. When the computer program is executed by the processor, the steps of the foregoing method embodiments are implemented. The computer program includes computer program code, and the computer program code may be in a form of source code, object code, or an executable file, some intermediate forms, or the like. The computer-readable medium may include: any entity or apparatus capable of carrying the computer program code, a recording medium, a USB flash drive, a removable hard disk, a magnetic disk, an optical disc, a computer memory, a read-only memory (ROM), a random access memory (RAM), an electrical carrier signal, a telecommunications signal, a software distribution medium, or the like.

The units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. Different methods may be used to implement the described functions for each particular application.

What is claimed is:

1. A scanning apparatus controlling method, applied to a LiDAR, wherein the LiDAR comprises a laser emission apparatus and at least two scanning apparatuses, and a laser beam emitted by the laser emission apparatus is reflected by the at least two scanning apparatuses and then is directed to a detection region, wherein the method comprises:
obtaining first movement information of a first scanning apparatus at a current moment, wherein the first movement information comprises any one or more of a position, an angular velocity and angular acceleration, and the first scanning apparatus is one of the at least two scanning apparatuses;
predicting a position of a second scanning apparatus at a next moment based on the first movement information and a relative positional relationship between the first scanning apparatus and the second scanning apparatus, wherein the second scanning apparatus is one of the at least two scanning apparatuses; and
controlling rotation of the second scanning apparatus based on the position of the second scanning apparatus at the next moment.

2. The method according to claim 1, wherein the first movement information comprises the position, the angular velocity and the angular acceleration, and predicting the position of the second scanning apparatus at the next moment based on the first movement information and the relative positional relationship between the first scanning apparatus and the second scanning apparatus comprises:
determining a theoretic position, a theoretic angular velocity and theoretic angular acceleration of the second scanning apparatus at the current moment based on the first movement information and the relative positional relationship between the first scanning apparatus and the second scanning apparatus; and
determining the position of the second scanning apparatus at the next moment based on the theoretic position, the theoretic angular velocity and the theoretic angular acceleration of the second scanning apparatus at the current moment, and a movement model of the second scanning apparatus.

3. The method according to claim 1, wherein the first movement information comprises the position, the angular velocity and the angular acceleration, and predicting the position of the second scanning apparatus at the next moment based on the first movement information and the relative positional relationship between the first scanning apparatus and the second scanning apparatus further comprises:
determining a position of the first scanning apparatus at the next moment based on the first movement information and a movement model of the first scanning apparatus; and
determining the position of the second scanning apparatus at the next moment based on the position of the first scanning apparatus at the next moment and the relative positional relationship between the first scanning apparatus and the second scanning apparatus.

4. The method according to claim 3, wherein after determining the position of the first scanning apparatus at the next moment, the method further comprises:
adjusting an angular velocity or angular acceleration of the first scanning apparatus based on the position of the first scanning apparatus at the next moment and a movement track of the first scanning apparatus that is planned in advance.

5. The method according to claim 1, wherein before obtaining the first movement information of the first scanning apparatus at the current moment, the method further comprises:
obtaining moments of inertia of the at least two scanning apparatuses; and
using a scanning apparatus with the largest moment of inertia as the first scanning apparatus when a difference between the moments of inertia of the at least two scanning apparatuses is greater than a preset difference.

6. The method according to claim 5, wherein after obtaining the moments of inertia of the at least two scanning apparatuses, the method further comprises:
using a scanning apparatus with the highest velocity as the first scanning apparatus when the difference between the moments of inertia of the at least two scanning apparatuses is less than or equal to the preset difference.

7. The method according to claim 1, wherein the method further comprises:
based on the first movement information, determining a first duration during which the first scanning apparatus rotates by a preset angular interval, and using the first duration as an emission time interval between emissions of two adjacent laser beams.

8. The method according to claim 1, wherein the method further comprises:
determining a first moment when the first scanning apparatus rotates to a preset first position, and a second moment when the first scanning apparatus rotates to a preset second position; and
controlling the laser emission apparatus to start emitting a laser beam at the first moment and stop emitting the laser beam at the second moment.

9. The method according to claim 8, wherein the first moment is a rising edge moment of a narrow pulse of a time synchronization signal, and before determining the first moment when the first scanning apparatus rotates to the preset first position, the method further comprises:
adjusting the angular velocity of the first scanning apparatus, so that the first scanning apparatus rotates to the first position at the first moment.

10. An electronic device, comprising a memory, a processor and a computer program stored in the memory and capable of running on the processor, wherein when the processor executes the computer program, to implement the processes of:
obtaining first movement information of a first scanning apparatus at a current moment, wherein the first movement information comprises any one or more of a position, an angular velocity and angular acceleration, and the first scanning apparatus is one of the at least two scanning apparatuses;
predicting a position of a second scanning apparatus at a next moment based on the first movement information and a relative positional relationship between the first scanning apparatus and the second scanning apparatus, wherein the second scanning apparatus is one of the at least two scanning apparatuses; and
controlling rotation of the second scanning apparatus based on the position of the second scanning apparatus at the next moment.

11. The electronic device according to claim 10, wherein the first movement information comprises the position, the angular velocity and the angular acceleration, and predicting the position of the second scanning apparatus at the next moment based on the first movement information and the relative positional relationship between the first scanning apparatus and the second scanning apparatus comprises:
determining a theoretic position, a theoretic angular velocity and theoretic angular acceleration of the second scanning apparatus at the current moment based on the first movement information and the relative positional relationship between the first scanning apparatus and the second scanning apparatus; and
determining the position of the second scanning apparatus at the next moment based on the theoretic position, the theoretic angular velocity and the theoretic angular acceleration of the second scanning apparatus at the current moment, and a movement model of the second scanning apparatus.

12. The electronic device according to claim 10, wherein the first movement information comprises the position, the angular velocity and the angular acceleration, and predicting the position of the second scanning apparatus at the next moment based on the first movement information and the relative positional relationship between the first scanning apparatus and the second scanning apparatus further comprises:
determining a position of the first scanning apparatus at the next moment based on the first movement information and a movement model of the first scanning apparatus; and
determining the position of the second scanning apparatus at the next moment based on the position of the first scanning apparatus at the next moment and the relative positional relationship between the first scanning apparatus and the second scanning apparatus.

13. The electronic device according to claim 12, wherein after determining the position of the first scanning apparatus at the next moment, the processes further comprise:
adjusting an angular velocity or angular acceleration of the first scanning apparatus based on the position of the first scanning apparatus at the next moment and a movement track of the first scanning apparatus that is planned in advance.

14. The electronic device according to claim 10, wherein before obtaining the first movement information of the first scanning apparatus at the current moment, the processes further comprise:
obtaining moments of inertia of the at least two scanning apparatuses; and
using a scanning apparatus with the largest moment of inertia as the first scanning apparatus, when a difference between the moments of inertia of the at least two scanning apparatuses is greater than a preset difference.

15. The electronic device according to claim 14, wherein after obtaining the moments of inertia of the at least two scanning apparatuses, the processes further comprise:
using a scanning apparatus with the highest velocity as the first scanning apparatus, when the difference between the moments of inertia of the at least two scanning apparatuses is less than or equal to the preset difference.
